(19) United States
(12) Patent Application Publication
(10) Pub. No.: US 2009/0047004 A1
(43) Pub. Date: Feb. 19, 2009

(54) Participant digital disc video interface

(76) Inventors: Steven Johnson, Hawthorne, CA (US); Anthony E. Cunha, Palos Verdes Estates, CA (US)

Correspondence Address: James P. Broder;Roeder & Broder LLP, 9915 Mira Mesa Blvd. Suite 300, San Diego, CA, 92131, US

(21) Appl. No.: 12/221,981

(22) Filed: Aug. 7, 2008

Related U.S. Application Data
(60) Provisional application No. 60/956,566, filed on Aug. 17, 2007.

(51) Int. Cl. H04N 5/00

(52) U.S. Cl. 386/126; 386/E05.064

(57) ABSTRACT

A digital disc interface for a plurality of audio-video streams produced from multiple recordings of an event is described. The video recordings include a primary audio-video recording, as well as one or more participant audio-video recordings. The interface provides time-synchronized rendering of a composite video image of the various video streams, including a main full-size rendering of one video stream, the accompanying audio stream, and miniaturized versions of participant streams. Using a video menu-driven interface, the consumer is able to simultaneously monitor the streams, and when desired, to navigate among the various video streams and select an alternative audio-video stream for full-size rendering and an accompanying audio stream.

### RELATED APPLICATION

This application claims the benefit under 35 U.S.C. § 119(e) on U.S. Provisional Application Ser. No. 60/956,566 filed on Aug. 17, 2007. The contents of U.S. Provisional Application Ser. No. 60/956,566 are incorporated herein by reference.

### BACKGROUND

A tremendous market exists for video recordings of noteworthy events, such as sporting contests, races, music/dance/acting performances, and the like. Collectively, the subject of each of these marketable video recordings is referred to as an “event” of interest to a large number of consumers. Today, consumers typically purchase or rent a video recording on a digital disc, such as a Digital Versatile Disc (DVD), and replay the event at home on their DVD player. This application concerns a means of implementing a user interface for the video content of the digital disk, and may be used on a digital versatile disc (DVD), a Blu-ray DVD (BD), or a high definition digital versatile disc (HD-DVD).

Typically, an event is presented from an encompassing (or primary) overview and/or may be presented from one or more alternative perspectives. For example, an event of consumer interest might be a noteworthy football playoff game, such as the Superbowl.

A consumer watching the event on television would typically observe a program largely presenting an overview of the game—introducing the players, discussing strategy, summarizing scoring, updating current field position, discussing the significance of various plays, and so on, until the game is wrapped up with final commentary. The video perspective would often be an overview as well, showing the array of both teams on the field, capturing the field of action, showing relative field position on kicks, updating player changes, reminding us of the score, and so on.

The Superbowl-watching consumer would also typically observe a number of alternate views. For example, the camera perspective might close in on the struggle to achieve the target first-down line, or on the quarterback's expression on an important play, or the dancing receiver who just scored. The consumer responds to increased participation in the event, conveyed through the personal perspective of one or more participants. The program is enriched and engages the individual by additionally conveying a personal perspective on the game. The consumer may later purchase a video recording of the Superbowl on a digital disc, motivated in part by extra features and perspectives included with the recording.

The typical consumer seeks additional control and flexibility in accessing a plurality of perspectives of a noteworthy event, without losing the general overview of the event or the time continuity of the event. The consumer desires increased personalization of the event experience through better incorporation of one or more experiences of participants. As such, a need exists in the art for a consumer interface to provide not only an event's primary video stream, but also an intuitive, simultaneous, and user-friendly video menu system providing for selection of one or more alternative participant views.

### SUMMARY

A primary composition video stream for an event is augmented with a plurality of participant video streams in an interactive digital disc recording for video consumers, such as a Digital Versatile Disc (DVD), a Blu-ray Disc (BD) or a High-Definition Digital Versatile Disc (HD-DVD). The recording system coordinates and time-synchronizes the participant streams with the primary stream.

When combined in a DVD, for example, the consumer is provided with an interactive menu-driven interface compatible with the DVD-Video (MPEG-2) standard. A first viewing interface allows the consumer to monitor a full-scale primary stream as well as a plurality of participant streams as miniaturized time-coordinated portal video streams. Using a DVD player's remote navigational and selection controls, the consumer is able to seamlessly select any of the portal video streams to replace the primary stream as the full-scale image. At the same time, the primary audio track is replaced with audio for the selected portal video. The consumer may return to the primary stream or switch to another of the portal audio/videos as the full-scale image and audio track at any time. The interface may optionally include an overview-update area to provide an updating overview of the event.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates a participant-cam system;

FIG. 2 illustrates a driver-cam system;

FIG. 3 is a block diagram of a synchronized multi-stream recorder;

FIG. 4 illustrates an example general-purpose computer system;

FIG. 5 illustrates a first DVD user interface;

FIG. 6 illustrates a plurality of multi-angle video streams; and

FIG. 7 illustrates a second DVD user interface with BOV overlays.

### DESCRIPTION

The following embodiments and aspects thereof are described and illustrated in conjunction with systems, apparatuses and methods meant to be exemplary and illustrative, not limiting in scope. In various embodiments, one or more of the above-described problems have been reduced or eliminated.

The following description sets forth numerous details to provide a thorough understanding of various aspects of the present invention. It will be apparent to those skilled in the art, however, that the present invention may be practiced without these specific details. In other instances, algorithms for processing data and symbolic representations of algorithmic operations are the means used by those skilled in the art to most effectively convey the substance of their work to others skilled in the art. An algorithm, as used herein, is a sequence of operations leading to a desired result, said operations requiring physical manipulations of physical quantities. Usually, though not necessarily, these quantities take the form of a sequence of electrical signals representing binary numbers to be stored, transferred, combined, compared, and otherwise manipulated.

The present invention also relates to apparatus for performing the operations herein. This apparatus may be specially constructed for the required purposes, or it may comprise one or more general-purpose computers selectively activated by one or more computer programs to achieve the required results. Such a computer program may be stored in any suitable computer-readable storage medium. A computer-readable storage medium includes any mechanism for storing or transmitting information in a form that is usable by a machine, such as a general-purpose computer.

The algorithms and displays presented herein are not inherently related to any particular computer or other apparatus. Various general-purpose systems may be used in accordance with the teachings herein, and it may prove expedient to construct more specialized apparatus to perform the algorithm operations. The required structure for a variety of these systems may appear from the description below. In addition, the present invention is not described with reference to any particular programming language. Those skilled in the art will appreciate that a variety of programming languages may be used to implement the teachings of the invention as described herein.

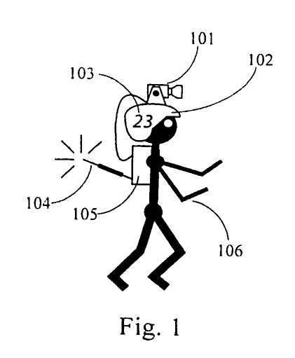

FIG. 1 is an illustration of an example participant-cam system. The illustration is not drawn to scale in order to emphasize aspects of the invention. A participant in an event is illustrated by stick FIG. 106. For example, participant 106 could be a football player in the SuperBowl, an Olympic speedskater, or a race car driver. Participant 106 is associated with a participant video stream as captured by video camera (videocam) 101. The video stream output of videocam 101 is connected to backpack 105, which contains a video processing unit and a transceiver. The transceiver is connected to antenna 104, which is able to intercommunicate with a controlling video base station (not shown).

Videocam 101 is aligned to capture approximately the same field of vision as participant 106. An audio transducer (not shown) in videocam 101 captures the same audio as heard by participant 106. Participant 106 may optionally wear a helmet 102 with a shock-absorbing camera mount and a participant label 103.

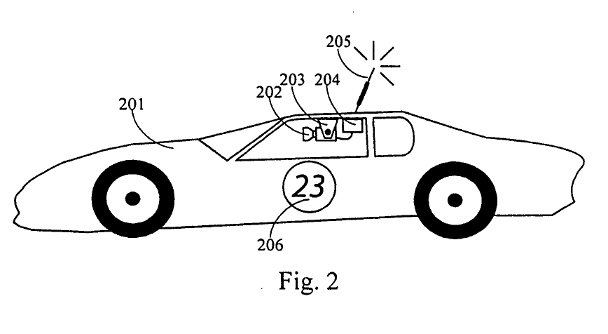

FIG. 2 illustrates an example embodiment of a participant-cam appropriate for a participant in an auto race. Referring to FIG. 2, car 201 represents a car entered in, for example, in an automobile race. The car is labeled with a driver number 206, and includes a videocam 202, a shock-absorbing camera mount 203, a video processing unit and transceiver 204, and an antenna 205. Videocam 202 is aligned to capture the same field of vision as the driver of car 201, and an audio transducer (not shown) captures the sounds heard within car 201. Additional equipment may include mechanism to adjust the pan, tilt and zoom of the videocam 202, or to change the amplification of the captured audio, from a remote system.

As can be appreciated by those with skill in the art, capturing, time-coordinating, and recording a plurality of mobile audio/video streams presents technical difficulties, particularly when the video streams must be precisely time-coordinated. As an example, consider an automobile race where cars typically achieve speeds of 200 miles per hour, or approximately 300 feet per second. To seamlessly switch back and forth from one car view to another, the time coordination should be precise. Although a plurality of video streams may be recorded and manually aligned through image recognition, the process is too labor intensive and time-consuming to be practical.

One or more high-resolution audio/video streams may be recorded on a digital video recorder (DVR). In one embodiment of the invention, a video processing unit (105 of FIG. 1 or 204 of FIG. 2) contains a DVR. To combat the adverse vibration of a racing car, the DVR may utilize specially constructed recorded devices such as might be found in a shock-resistant flight recorder. In this embodiment, a video base station transmits time-stamp messages to each of the participant-cams. The time-stamp messages are encoded and incorporated in the recorded audio/video stream. Because the video base station transmits coordinating control signals and no participant video stream is transmitted, the embodiment advantageously minimizes bandwidth for time-coordination of the participant streams, and advantageously does not subject any of the video streams to transmission interference. At the end of the race, the contents of the various DVRs are collected manually and time-coordinated by aligning the time stamps within the recordings.

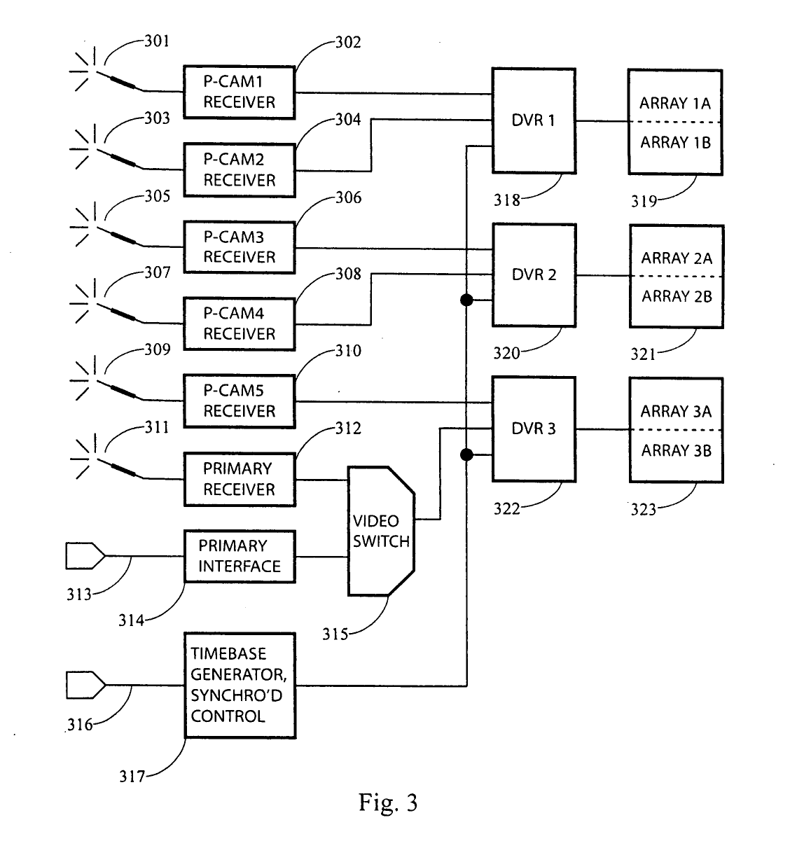

In an alternate embodiment, the video processing unit does not contain a DVR. Instead, each of the audio/video streams is transmitted for recording at the video base station as illustrated in FIG. 3. In FIG. 3, antennas 301, 303, 305, 307, and 309 receive modulated signals corresponding to the video streams broadcast by, for example, five example participant-cams. In alternate embodiments of the invention, a differing number of participant-cams may be used. In addition, alternate embodiments of the invention may record one or more additional audio tracks without associated video tracks. Receivers 302, 304, 306, 308, and 310 demodulate the received signals to recreate the five example video streams.

The video base station may also receive a primary audio/video stream, provided by either wireless transmission or direct connection. A wireless primary stream transmission is received by antenna 311 and demodulated by receiver 312. Alternatively, the primary audio/video stream is received by direct connection to input 313 and primary interface 314. For example, the event may be a Superbowl game, with a live video broadcast providing an overview of the game. In such a case, the live video stream may be considered the primary audio/video stream. A direct audio/video feed may be obtained from the primary distributor, or may be received by wireless transmission, as selected by video switch 315.

At the base station, the video streams are recorded in parallel in three example recorders 318, 320, 322. By recording a number of video streams in parallel, the large overall bandwidth requirements are advantageously distributed. Each DVR contains a controller and interfaces with an array of hard disc drives 319, 321, 323, and each records two example video streams. The storage capacity required for a five-hour event with a multitude of participant-cams might, for example, be 750 Gigabytes (GB) of storage. In this example, each DVR might require 250 GB of storage for the two video streams. In addition, example arrays 319, 321, 323 may contain redundant storage devices. In one embodiment, the disc array in each DVR is configured as a RAID1 array. In a RAID1 array, the disc array is divided into two halves, and one half is recorded as a duplicate of the other half. If any drive in the RAID1 array fails, a duplicate drive is available as a replacement. In FIG. 3, each disc array 319, 321, 323 is illustrated as two mirrored halves, and each contains 500 GB of storage for the example event.

It will be noted by those of skill in the art that the number of DVR recorders and/or disc storage units may be changed without departing from the spirit of the invention. In a first alternate embodiment, a single high-speed DVR is used to record all video streams in parallel. In a second alternate embodiment, there is a separate, dedicated DVR for each video stream to be recorded. Similarly, the storage elements of the recording system, illustrated by arrays 319, 321, and 323, may be reconfigured or provided with a larger or smaller number of disc arrays. Each disc array may further be reconfigured, for example, as a non-redundant array, a RAID 0 array, a RAID 5 array, or a RAID 10 array.

Time stamp information is included in each of the recorded audio/video streams. Time base generator and synchronized controller 317 may be configured to accept an external time-base generation signal on input 316, or to provide an internally generated time-base. When using an external time-base generation signal on input 316, the external time-base generation signal is buffered and distributed to all of the DVRs. Alternatively, the internal time-base generator of 317 may generate coded time reference information for incorporation in the video streams. Time-base generator 317 also contains circuitry to synchronously control one or more DVRs, as illustrated with the three example DVRs 318, 320, 322.

At the end of the event, the drive arrays may optionally be collected for further processing at a central editing studio, or further video editing may occur at the video base station.

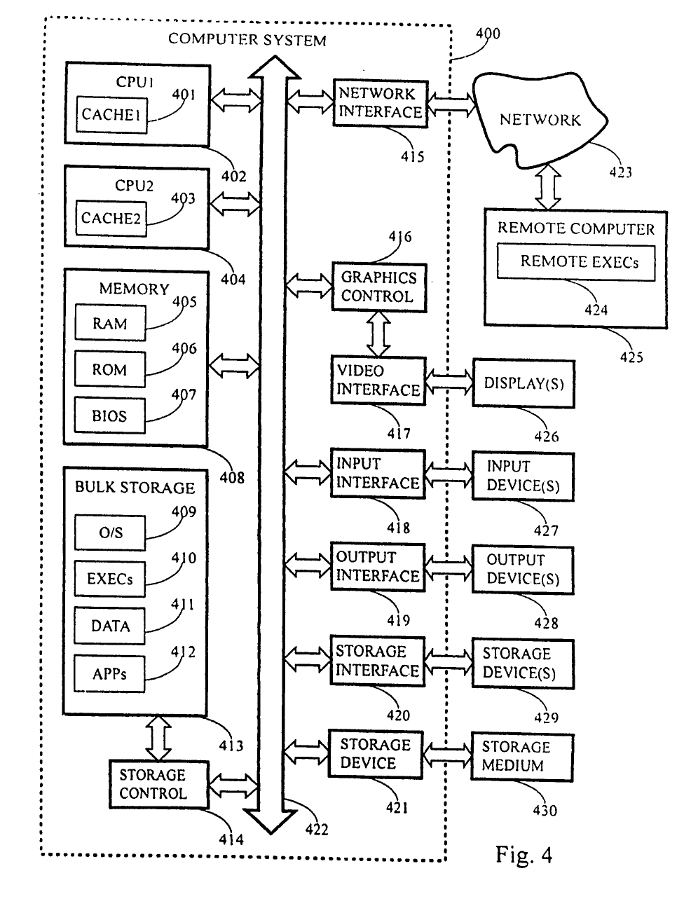

FIG. 4 illustrates suitable components in an exemplary embodiment of a general purpose computer system for further video editing. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computer system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing the invention may include a general-purpose computer system 400. Computer system 400 accesses one or more applications and peripheral drivers directed to a number of functions described herein. Components of the computer system 400 may include, but are not limited to, a CPU or central processing unit 402, a system memory 408, and a system bus 422 that couples various system components including the system memory 408 to the processing unit 402. As used by those skilled in the art, a signal “bus” refers to a plurality of digital signal lines serving a common function. The system bus 422 may be any of several types of bus structures including a memory bus, a peripheral bus, and a local bus using any of a variety of bus architectures. By way of example, and not limitation, such architectures include Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

An operating system manages the operation of computer system 400, including the input and output of data to and from applications (not shown). The operating system provides an interface between the applications being executed on the system and the components of the system. According to one embodiment of the present invention, the operating system is a Windows® 95/98/NT/XP/Vista/Mobile operating system, available from Microsoft Corporation of Redmond, Wash. However, the present invention may be used with other suitable operating systems, such as an OS-X® operating system, available from Apple Computer Inc. of Cupertino, Calif., a UNIX® operating system, or a LINUX operating system.

The computer system 400 may include a variety of computer-readable media. Computer-readable media can be any available media that can be accessed by the computer system 400 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, random access memory (RAM), read-only memory (ROM), electrically erasable programmable ROM (EEPROM), flash memory or other memory technology, compact-disc ROM (CD-ROM), digital versatile discs (DVD) or other optical disc storage, magnetic tape cassettes, magnetic tape, hard magnetic disc storage or other magnetic storage devices, floppy disc storage devices, magnetic diskettes, or any other medium which can be used to store the desired information and which can accessed by the computer system 400.

Communication media may also embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared, cellular networks, and other wireless media.

The system memory 408 includes computer storage media in the form of volatile and/or nonvolatile memory such as read only memory (ROM) 406 and random access memory (RAM) 405. A basic input/output system 407 (BIOS), containing the basic routines that help to transfer information between elements within computer system 400, such as during start-up, is typically stored in ROM 406 and other non-volatile storage, such as flash memory. Additionally, system memory 408 may contain some or all of the operating system 409, the application programs 412, other executable code 410 and program data 411. Memory 408 typically contains data and/or program modules that are immediately accessible to and/or presently being operated on by CPU 402. Optionally, a CPU may contain a cache memory unit 401 for temporary local storage of instructions, data, or computer addresses.

The computer system 400 may also include other removable/non-removable, volatile/nonvolatile computer storage media. By way of example only, FIG. 4 illustrates a bulk storage 413 that reads from or writes to one or more magnetic disc drives of non-removable, nonvolatile magnetic media, and storage device 421 that may be an optical disc drive or a magnetic disc drive that reads from or writes to a removable, a nonvolatile storage medium 430 such as an optical disc or a magnetic disc. Other removable/non-removable, volatile/nonvolatile computer storage media that can be used in the exemplary computer system 400 include, but are not limited to, magnetic tape cassettes, flash memory cards, digital versatile discs, digital video tape, solid state RAM, solid state ROM, and the like. Bulk storage 413 and the storage device 421 may be connected directly to the system bus 422, or alternatively may be connected through an interface such as storage controller 414 shown for bulk storage 413. Storage devices may interface to computer system 400 through a general computer bus such as 422, or may interconnect with a storage controller over a storage-optimized bus, such as the Small Computer System Interface (SCSI) bus, the ANSI ATA/ATAPI bus, the Ultra ATA bus, the FireWire (IEEE 1394) bus, or the Serial ATA (SATA) bus.

The storage devices and their associated computer storage media, discussed above and illustrated in FIG. 4, provide storage of computer-readable instructions, executable code, data structures, program modules and other data for the computer system 400. In FIG. 4, for example, bulk storage 413 is illustrated as storing operating system 409, application programs 412, other executable code 410 and program data 411. As mentioned previously, data and computer instructions in 413 may be transferred to system memory 408 to facilitate immediate CPU access from processor 402. Alternatively, processor 402 may access stored instructions and data by interacting directly with bulk storage 413. Furthermore, bulk storage may be alternatively provided by a network-attached storage device (not shown), which is accessed through a network interface 415.

A user may enter commands and information into the computer system 400 through the network interface 415 or through an input device 427 such as a keyboard, a pointing device commonly referred to as a mouse, a trackball, a touch pad tablet, a controller, an electronic digitizer, a microphone, an audio input interface, or a video input interface. Other input devices may include a joystick, game pad, satellite dish, scanner, and so forth. These and other input devices are often connected to CPU 402 through an input interface 418 that is coupled to the system bus, but may be connected by other interface and bus structures, such as a parallel port, a game port or a universal serial bus (USB). A display 426 or other type of video device may also be connected to the system bus 422 via an interface, such as a graphics controller 416 and a video interface 417. In addition, an output device 428, such as headphones, speakers, or a printer, may be connected to the system bus 422 through an output interface 419 or the like.

The computer system 400 may operate in a networked environment using a network 423 to one or more remote computers, such as a remote computer 425. The remote computer 425 may be a terminal, a personal computer, a server, a router, a network PC, a peer device or other common network node, and typically includes many or all of the elements described above relative to the computer system 400. The network 423 depicted in FIG. 4 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 4 illustrates remote executable code 424 as residing on remote computer 425. It will be appreciated that the network connections shown are exemplary and other means of establishing a communications link between the computers may be used.

Collectively, these elements are intended to represent a broad category of computer systems, including but not limited to general purpose computer systems based on one or more members of the family of CPUs manufactured by Intel Corporation of Santa Clara, Calif., the family of CPUs manufactured by Advanced Micro Devices (AMD), Inc., of Sunnyvale, Calif., or the family of ARM CPUs, originally designed by Advanced RISC Machines, Ltd., as well as any other suitable processor. Of course, other implementations are possible. For example, the video editing functionalities described herein may be implemented by a plurality of video and computer sub-systems communicating over a backplane.

Various components of computer system 400 may be rearranged, deleted, or augmented. For example, system bus 422 may be implemented as a plurality of busses interconnecting various subsystems of the computer system. Furthermore, computer system 400 may contain additional signal busses or interconnections between existing components, such as by adding a direct memory access unit (not shown) to allow one or more components to more efficiently access system memory 408.

As shown, CACHE1 and CPU1 are packed together as “processor module” 402 with processor CPU1 referred to as the “processor core.” Alternatively, cache memories 401, 403, contained in 402, 404 may be separate components on the system bus. Furthermore, certain embodiments of the present invention may not require nor include all of the above components. For example, some embodiments may include a smaller number of CPUs, a smaller number of network ports, a smaller number of storage devices, or a smaller number of input-output interfaces. Furthermore, computer system 400 may include additional components, such as one or more additional central processing units, such as 404, storage devices, memories, or interfaces. In addition, one or more components of computer system 400 may be combined into a specialized system-on-a-chip (SOC) to further system integration. In some computer system environments where component count is critical, the entire computer system may be integrated in one or more very large scale integrated (VLSI) circuits.

As discussed below, in one implementation, operations of one or more of the video editing functions described herein is implemented as a series of software routines executed by computer system 400. Each of the software routines comprises a plurality or series of machine instructions to be executed by one or more components in the computer system, such as CPU 402. Initially, the series of instructions may be stored on a storage device, such as bulk storage 413. However, the series of instructions may be stored in an EEPROM, a flash device, or a DVD. Furthermore, the series of instructions need not be stored locally, and could be received from a remote computer 425 or a server on a network, via network interface 415.

A digital disc may be recorded in a standardized video format, such as a format instituted by the Motion Picture Experts Group (MPEG). Among the MPEG standards is the MPEG-2 (ISO/IEC13818) standard, an international standard for coding audio-visual information in a compressed digital format. A consortium of manufacturers, the DVD Forum, promotes uniform standards, such as an MPEG-2 standard for DVD consumer videos known as the DVD-video specification. The Blu-ray (BD) and HD-DVD are competing standards for higher-definition video recordings. Each supports a number of standard formats, including backward compatible MPEG-2, and higher resolution “MPEG-4 AVC” (H.264) and “VC-1” standards.

Each of the specifications includes rudimentary features for implementing a user interface. The DVD-Video specification, for example, includes a container format known as a VOB (alternatively known as a “DVD-Video Object” or a “Versioned Object Base”) file. The VOB file contains the actual Video, Audio, Subtitles, and Menu contents in a stream form. The DVD-video specification allows for a limited interaction between the consumer and the content of the disc. The interaction is much less than users are accustomed to on a computer playing a CD-ROM, but more than users are accustomed to on a video tape player or laser disc player.

For most DVD-video discs, the primary means of DVD consumer interaction is through the use of video menus. Most DVD-video discs default to an initial selection menu for accessing various key features of the disc. In a DVD-video of a movie, for example, a disc selection menu might include selections for playing the movie, starting at a different chapter in the movie, viewing selected stills from the movie, viewing an interview or commentary with directors, performers or critics, extra features, out-takes, hidden “easter eggs”, and even simple games. Some discs provide alternate story lines or alternate language versions accessed via the menu system.

A further personalization of the user experience is available in some DVDs. A consumer may desire, for example, to view a movie from the eyes of a director, an actor, a critic or some other relevant participant in the subject of the movie. Some DVDs, for example, offer an alternative audio commentary of one or more renowned critic(s), alerting the consumer to subtle techniques employed in making the film.

The DVD-Video standard also provides support for Buttons-Over-Video (BOV). A menu system typically consists of a backdrop video image with a plurality of display button areas for an on-screen menu, each of said button areas selected by using a DVD player's controls or remote control. The typical DVD player has a remote control with navigational (“Up, Down, Left, Right”) controls and a selection (“SELECT” or “ENTER” or “OK”) control for on-screen menus. When a video selection menu is initially displayed, a visual indicator, such as a sub-picture frame (or icon or pointer) indicating a default selection in the video display, is typically highlighted. The user typically navigates from a first highlighted selection to a second highlighted selection by engaging one or more of the navigational controls, and in response, the first visual indicator is removed and a second visual indicator, such as a sub-picture frame (or icon or pointer), for the second selection is highlighted. When a selection control is engaged, the contents of the disc associated with the currently highlighted selection are accessed.

The MPEG-4 and VC-1 standards also provide support for implementing control menus on top of a background video image. For example, support for the Java programming language on BD was announced at the 2005 JavaOne trade show. The Java version for BD players is known as BD-J, and is a subset of the Globally Executable MHP (GEM) standard. For clarity, the invention is described in terms of the limited, rudimentary commands of the DVD-Video specification, but may be implemented in any suitable programming language. Alternatively, the interface may be implemented in a programming language for HD-DVD, such as the HDi Markup Language developed in part by Microsoft, Corporation of Redmond, Wash.

Menus are supported by an underlying command structure. In a DVD, a command may branch to other commands, and sequential commands may be combined to form a program chain (PGC). Commands are used to control the player's settings, move to different sections of the disc and control such elements as the selection of which audio streams, video streams, camera angles, sub-picture, and so forth, on the disc are decoded by the DVD player. The content of a disc is typically organized as “titles” (as in titles of movies) and “chapters” (as in sections of a movie). Typically, a remote control has a “title” control to allow the user to select the next title of a distinct creative work on a disc, and a “chapter” control to allow the user to select the next chapter in a currently accessed creative work on a disc. Following a PGC is seamless, in the sense that the consumer should not perceive a video glitch as one chapter flows into the next. PGCs may be used, in some instance, to create alternate chapter flows or alternate story lines. For example, a PGC may be used to create two distinct program flows for the same movie. A first program might show only ‘G’ rated scenes suitable for a general audience, and a second program might show additional ‘R’ rated scenes suitable for a more adult audience.

The chapters can be automatically sequenced through the use of a PGC stored on the DVD. Commands pertinent to a particular DVD may be stored on the DVD in an “Information” (IFO) file. The playback sequence, in response to various consumer control actions, is defined in the IFO file. Further, DVD-Video standards allow for customization of the DVD viewing experience. For example, a consumer may be able to change the language of the audio accompanying a video, may be able to control the display of subtitles, may be able to modify the screen image or format, and so on. For example, a DVD remote control will often have an “audio” control to select translations for various languages and a “zoom” control to enlarge a central portion of a video image to fill the entire screen.

A further feature of the DVD-Video MPEG-2 standard is support for multiple angle (multi-angle) video streams. In a multi-angle video stream, a plurality of video streams are time-synchronized and provided on the DVD. Typically, a consumer is able to view one video stream from a multi-angle DVD at a time. The consumer may be able to switch from one video stream to another using an “angle” button on the DVD player's remote. The MPEG-2 standard provides for seamless switchover of the two video streams. The MPEG-4 and VC-1 standards also provide support for multi-angle video streams.

A Superbowl DVD, for example, might contain two video streams. The first video stream could be a broadcast version of the game; the second video stream could be a close-up on the home-team quarterback. A consumer who was aware of the second stream could access it by pushing the “angle” button, and switch back to the broadcast stream by pushing it again.

Similarly, the MPEG-2 standard supports multiple audio streams. The consumer may be able to switch from one audio stream to another by pushing the “audio” button on the DVD player's remote.

Although the DVD-video standards provide for consumer selection of one of a plurality of camera views when viewing an event, or one of a number of audio recordings when listening to an event, the consumer interface for those selections is typically counter-intuitive. As opposed to the DVD menu system, which relies on interaction with a visual menu, the operator of the remote “angle” and “audio” controls operates without a visual interface and is provided a less than optimal viewing experience.

For example, the center of action in a Superbowl play may shift from a first camera viewing the quarterback with a first audio track for the pass protection pocket, to a second camera viewing a downfield receiver with a second audio track for the receiver and defending linebacker. Suppose, for illustrative purposes, that a DVD-video contains these video and audio tracks and other multi-angle tracks. In a DVD player remote with typical “angle” and “audio” controls, the consumer is watching a first video selection and hearing a first audio selection. The consumer is unaware of the video or audio content of other multi-angle views or audio recordings. The consumer may, by trial and error, repeatedly push the angle control until he comes across a better video track, and then repeat pushing the audio control until the corresponding better audio track is reached. During a critical play, it is unlikely that the consumer will interrupt the event view to search for better alternatives.

Returning to FIG. 3, at the end of the event there are a plurality of recorded video streams. The video streams may be recorded in any suitable format, such as the compressed MPEG-2 or MPEG-4 format, or an uncompressed 8 or 10 bit raw video. The video streams are combined to produce the DVD content using a video editor program, such as Final Cut Pro® from Apple Computer of Cupertino, Calif., and a DVD authoring program, such as Scenarist® from Sonic Solutions of Novato, Calif., on a general-purpose computer system such as that shown in FIG. 4.

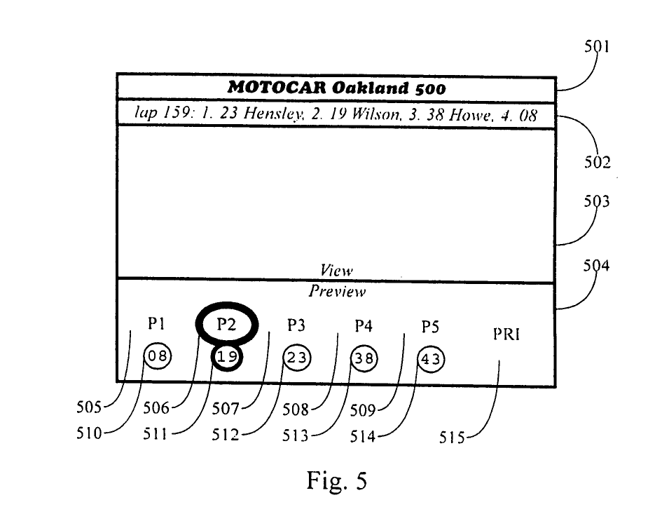

An example image of an interface for the output of the video editing process is shown in FIG. 5, an illustration of a television screen while playing the DVD. Several areas within the screen image are delineated. Banner area 501 displays the event title and sponsor information. In this example, a hypothetical MOTOCAR race is shown. Overview-update area 502 provides the consumer with general information about the progress of the event. For example, overview-update area 502 may provide a scrolling text message providing the placement of the various driver-cars at the beginning of each lap of the race. View area 503 provides the main full-scale video image perceived by the consumer. Preview area 504 contains a video portal for each of the participant video streams 505-509. A miniaturized low-resolution version of a participant video stream is rendered in a portal. The portal versions are denoted “P1”-“P5”. The consumer is informed of the associated participant for each portal in labels 510-514. Preview area 504 also contains a miniaturized low-resolution version of the primary video stream in portal 515, denoted “PRI”. As appreciated by those of skill in the art, the various areas of the interface screen image may be rearranged or resized without departing from the spirit of the invention. In alternate embodiments of the invention, a differing number of participant-cams may be used, and interface areas may be added or deleted.

The operation of the interface is similar to that of a typical DVD video-driven menu system. In FIG. 5, various possible control selections are indicated by BOV areas with large borders 505-509 and 515. A currently selected BOV area is indicated, as in this example, by the darkened boundary frame of portal for stream P2, 506. Other possible BOV selection areas not currently highlighted are shown in gray. If the consumer is satisfied with the current image view, he or she does nothing. The consumer can complete selection of the P2 stream by engaging a selection control on the DVD player or remote control. Alternatively, the consumer may navigate to other streams using navigational controls on the remote control or DVD player. For example, by engaging a “left” control, the consumer may navigate to indicate the P1 area and remove the darkened frame of the P2 area. The consumer may alternatively navigate to the P4 area by engaging a “right” control twice.

When the consumer completes selection of a participant stream by engaging a selection control on the DVD player or remote control, the DVD program sequence sends commands to the DVD player to switch audio/video streams. The DVD player responds by seamlessly switching the video image to show the selected participant stream as the full-sized high-resolution image in view area 503, and by switching the audio to the accompanying participant audio stream. Overview-update area 502 and PRI stream area 515 alert the consumer to significant actions occurring in other views, and keep the consumer informed of game progress.

In one implementation, overview-update area 502 contains scrolling game summary text messages as needed to replace significant primary stream commentary as determined by a video editor. In an alternate implementation, overview-update area 502 provides scrolling text corresponding to the actual primary audio stream commentary.

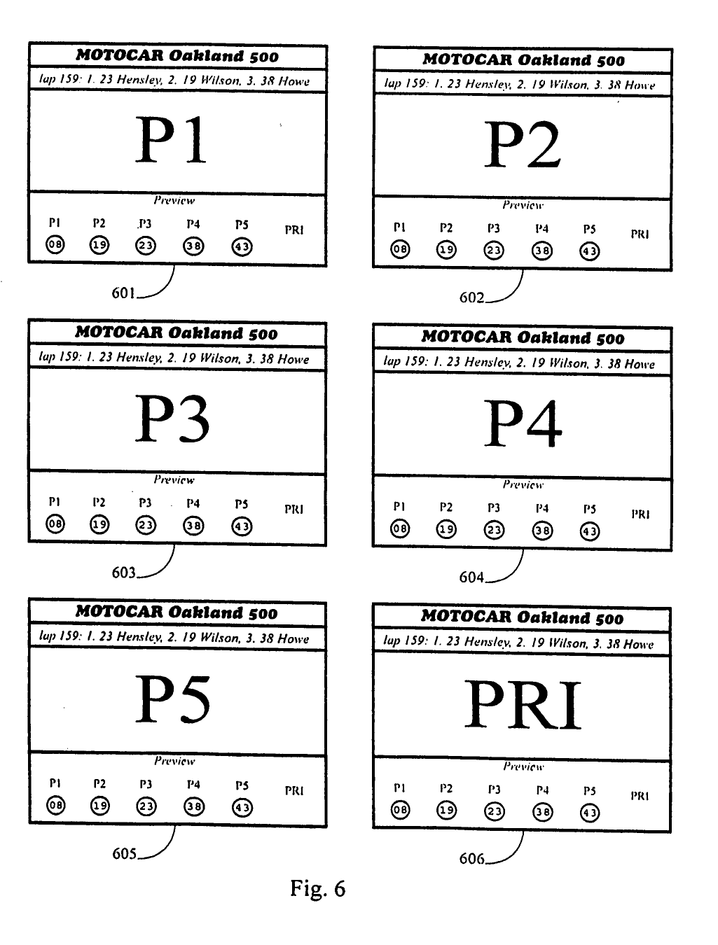

In one embodiment of the invention, the example interface of FIG. 5 is provided by switching between a plurality of multi-angle video and audio streams. As shown in example FIG. 3, six example audio/video streams for the event are recorded. The six video streams are combined as described below to from six constituent multi-angle DVD-video streams as shown in FIG. 6 and described further below.

The six recorded video streams are first time-synchronized, in one implementation, by aligning their recorded time-stamp information. After synchronization, at a particular time during the event, six time-coordinated video frames are observable, one for each recorded video stream. The video frames are denoted P1-P5 for the five participant video frames, respectively, and denoted PRI for the main view video frame. A miniaturized, low-resolution copy of each time-synchronized recorded video stream is then produced. Each miniaturized frame of a participant view has an oval-shaped border image overlaid to produce the oval-shaped framing of the portal video images streams. In one embodiment, each miniaturized frame of the main view remains rectangular.

Referring to FIG. 6, it may be observed that there are six constituent video streams, 601-606, corresponding to possible selection to primarily view either the main view or one of five participant views. It may be observed that, in each time-coordinated frame of FIG. 6, there is a preview area, a banner area, and an overview-update area, as shown in FIG. 5. In a set of time-coordinated frames of the six constituent streams 601-606, the preview, banner, and overview-update areas are identical in each of the frames. Further, in each of the constituent streams, none of the BOV areas is highlighted.

The preview area is composed by aligning the miniaturized and framed participant streams and the miniaturized main video stream in particular screen locations within the preview area. The miniaturized video images of the six streams are placed and overlaid on a background image in a video editor application on a computer system.

The banner area is composed by overlaying a textual description of the event and/or sponsor in a rectangular area. The banner area may additionally contain sponsor or event logos, advertising, or other text or images.

The overview-update area is composed by obtaining or producing a running commentary on the event, and encoding a visual image of the commentary as a scrolling text message. For example, the commentary may be obtained as a closed-caption interpretation of the audio commentary in the audio stream accompanying the main video stream. Alternatively, statistics related to the event may be displayed. In the example of FIG. 6, the relative position of cars in the race after each lap is listed in a scrolling text display.

As in FIG. 5, the large central viewing area of each constituent stream (akin to view area 503) provides the main full-scale video image perceived by the consumer. In FIG. 6, the six constituent streams provided six differing full-scale video images in the central viewing area, one stream for each viewpoint. In 601, for example, the frame for the first participant video stream is rendered in the primary viewing area. Frames 602-605 each correspond to one of the remaining participant video streams, P2-P5, as the desired primary viewing area. Frame 606 is the frame for the main video stream as the desired primary viewing area. Each stream is created by inserting a recorded video stream in a large central viewing area surrounded by a banner area, a update-overview area, and a preview area using a video editor application on a computer system. Each composed constituent stream is combined as a multi-angle video stream in a VOB as described in the DVD-Video specification. For alternative disc formats, such as MPEG-4 and VC-1, a different container format may be used.

An alternative audio control interface may also be provided. In most DVD players, a “Menu” control button on a player remote control, for example, freezes the currently playing video selection and displays a video menu. In one embodiment, the resulting video menu is used to control selection of an audio track among the plurality of recorded audio tracks. The resulting video menu contains a textual list of the source of each audio track, (“driver 23: Hensley,” “driver 19: Wilson,” and so on) and highlights a current choice of audio track. The user is able to navigate among the various audio track choices using the player's navigational controls. As the user changes from a previous choice to a current choice, the highlighting of the previous choice is removed, and the current choice is highlighted. When the user is satisfied with the current choice, the select or “OK” button is pressed. In response, the audio choice menu disappears, the video rendering unfreezes at its previous stopping point, and the audio output switches to the time-synchronized audio of the user choice.

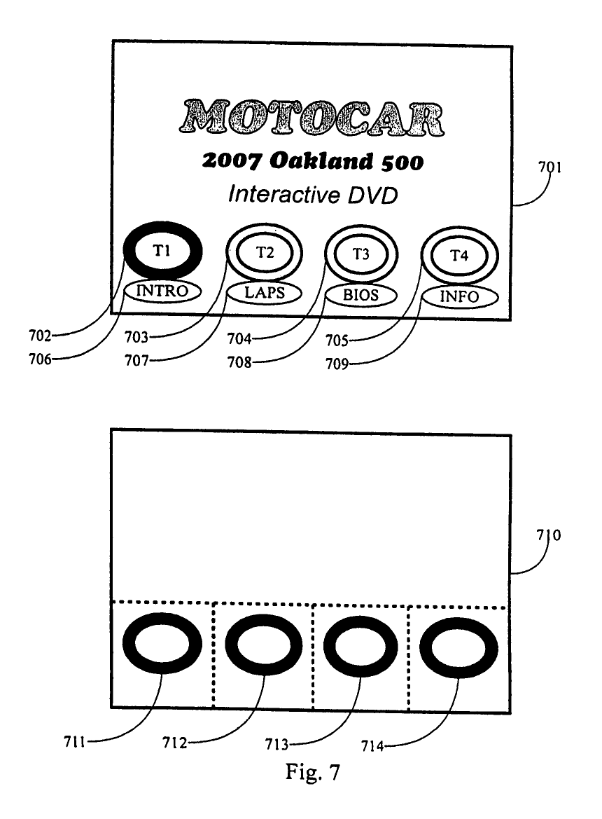

A second example video interface for the DVD is illustrated in FIG. 7, and may represent an example default initial start-up (or “First-Play”) menu for the DVD. Screen image 701 is an example of a screen observed by the consumer. Video portal images 702-705 provide miniaturized, low-resolution video streams corresponding to the various possible selections. Selections are explained in labels 706-709. Overlay BOV video images are shown in screen frame 710. BOV video image 711 is an example overlay image that, when aligned imaged on top of screen image 701 highlights a selection 702 labeled “INTRO” and corresponding to a video portal image T1, as shown. For example, an introduction to the race may be provided in a video stream introducing the race and giving various related information. As before, the consumer may initiate the introduction by engaging a “select” button, or may highlight other selections by engaging a navigational (“left”, “right”) control.

A feature of the current invention is that the interface operates reliably, robustly, and efficiently with a number of differing manufacturer's players. For example, a number of DVD players provide a sub-optimal implementation of the BOV standard. In many players, selection of a BOV button control results in loss of the overlay BOV image. Without a robust control BOV refreshment mechanism, the user loses control of the interface. As mentioned above, the DVD-Video specification allows for a number of BOV cell areas within the video image. In one implementation, the loss of control problem is ameliorated when BOV cell areas are periodically refreshed by encoding periodic cell refresh operations in a VOB stream. In another embodiment, BOV refreshes are desirably minimized by refreshing sub-components of cells as needed.

Those of skill in the art will appreciate that the interface implementation methods discussed herein are equally applicable in a HD-DVD or BD interface. The HD-DVD or BD interface may be implemented in a backwards compatible disc in MPEG-2 format with higher resolution. Alternatively, the composition of the interface may be implemented as a combination of constituent video streams composed in the same manner as for DVD-Video (albeit at a higher resolution), while menu implementation program routines, such as the highlighted framing of video menu selections, may be migrated to area frames highlighted using a BD-J standard, for example.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A digital disc consumer interface for a primary video stream and one or more time-synchronized participant video streams comprising
a video image including a plurality of incorporated video images, said plurality of incorporated video images including
a miniaturized rendering of the primary video stream;
a synchronized miniaturized rendering of the one or more participant video streams;
two or more layover button-over-video images, each of said button-over-video images to highlight one of the miniaturized renderings of the primary or one of the participant video streams; and
a full-scale rendering of one of the primary or one of the participant video streams; and
an initial layover button-over-video image to highlight a default video image in the miniaturized renderings of the primary or the one of more participant video streams;
an initial full-scale rendering of the default video image; and
a digital disc sequencing program operative to
replace a current layover button-over-video image with an alternative layover button-over-video image in response to a navigational (“left”, “right”, “up,” or “down”) consumer command to a DVD player or the DVD player's remote control; and
select a full-scale rendering of a video stream corresponding to a currently highlighted miniaturized rendering of the primary or one of the participant video streams to replace the current full-scale rendering in response to a selection (“select” or “enter” or “OK”) consumer command to a DVD player or the DVD player's remote control.

2. The interface of claim 1, further comprising
a digital disc audio recording including a plurality of incorporated audio streams, said plurality of incorporated audio streams including
an audio stream accompanying the primary video stream;
one or more audio streams, each of said audio streams accompanying one of the one or more participant video streams; and
an output audio stream consisting of one of the primary or one of the participant audio streams; and
an initial output audio stream accompanying the default video image; and
a digital disc sequencing program operative to
select an audio stream accompanying a currently highlighted miniaturized rendering of the primary or one of the participant video streams to replace the current output audio stream in response to a selection (“select” or “enter” or “OK”) consumer command to a digital disc player or the digital disc player's remote control.

3. The interface of claim 1, wherein the video image including a plurality of incorporated video images, includes a video stream of an update-overview area consisting of a scrolling text image providing additional information about the depicted images.

4. The interface of claim 3, wherein the update-overview area includes a text image providing a closed-captioning of commentary in an audio stream accompanying a primary video stream.

5. A computer-readable medium comprising computer-readable instructions operative, when executed, to cause a digital disc player to decode an interactive digital disc consumer interface for a primary video stream and one or more time-synchronized participant video streams comprising
a video image including a plurality of incorporated video images, said plurality of incorporated video images including
a miniaturized rendering of the primary video stream;
a synchronized miniaturized rendering of the one or more participant video streams;
two or more layover button-over-video images, each of said button-over-video images to highlight one of the miniaturized renderings of the primary or one of the participant video streams; and
a full-scale rendering of one of the primary or one of the participant video streams; and
an initial layover button-over-video image to highlight a default video image in the miniaturized renderings of the primary or the one of more participant video streams;
an initial full-scale rendering of the default video image; and
a digital disc sequencing program operative to
replace a current layover button-over-video image with an alternative layover button-over-video image in response to a navigational (“left”, “right”, “up,” or “down”) consumer command to a digital disc player or the digital disc player's remote control; and
select a full-scale rendering of a video stream corresponding to a currently highlighted miniaturized rendering of the primary or one of the participant video streams to replace the current full-scale rendering in response to a selection (“select” or “enter” or “OK”) consumer command to a digital disc player or the digital disc player's remote control.

6. The computer-readable medium of claim 5, wherein the consumer interface further comprises
a digital disc audio recording including a plurality of incorporated audio streams, said plurality of incorporated audio streams including
an audio stream accompanying the primary video stream;
one or more audio streams, each of said audio streams accompanying one of the one or more participant video streams; and
an output audio stream consisting of one of the primary or one of the participant audio streams; and
an initial output audio stream accompanying the default video image; and
a digital disc sequencing program operative to
select an audio stream accompanying a currently highlighted miniaturized rendering of the primary or one of the participant video streams to replace the current output audio stream in response to a selection (“select” or “enter” or “OK”) consumer command to a digital disc player or the digital disc player's remote control.

7. The computer-readable medium of claim 5, wherein the video image including a plurality of incorporated video images, includes a video image of an update-overview area consisting of a scrolling text image providing additional information about the depicted images.

8. The computer-readable medium of claim 7, wherein the update-overview area includes a text image providing a closed-captioning of commentary in an audio stream accompanying a primary video stream.

9. A method to compose a multi-angle digital disc, the method comprising
receiving a time-base reference;
recording a primary video stream with embedded time-stamp information from the time-base reference;
recording one or more participant video streams with embedded time-stamp information from the time-base reference;
replicating each of the primary video stream and the one or more participant streams in a miniaturized low-resolution format video stream;
embedding each of the miniaturized video streams in a known location within a video screen layout;
aligning a button-over-video area with each of the known locations of the miniaturized video streams within the video screen layout;
composing two or more video streams, each of said video streams combining a full scale version of one of the video streams among the primary video stream and the one or more participant streams with the video screen layout including the embedded miniaturized video streams and the button-over-video areas;
combining the two or more composed video streams in a synchronized multi-angle digital disc.

10. The method of claim 9, the method further comprising
receiving a time-base reference;
recording a primary audio stream with embedded time-stamp information from the time-base reference;
recording one or more participant audio streams with embedded time-stamp information from the time-base reference;
combining each of the recorded audio streams with the a corresponding video stream in a synchronized multi-angle digital disc.

11. The method of claim 9, wherein the composed two or more video streams each include a video stream of an update-overview area consisting of a scrolling text image providing additional information about the depicted images.

12. The method of claim 11, wherein the update-overview area includes a text image providing a closed-captioning of commentary in an audio stream accompanying a primary video stream.
